(19) United States
(12) Patent Application Publication
(10) Pub. No.: US 2010/0079915 A1
(43) Pub. Date: Apr. 1, 2010

(54) MAGNETIC HEAD ASSEMBLY AND MAGNETIC DISK DEVICE

(75) Inventor: Takuma Kido, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/561,913

(22) Filed: Sep. 17, 2009

(30) Foreign Application Priority Data
Oct. 1, 2008 (JP) 2008-256737

(51) Int. Cl. G11B 5/48

(52) U.S. Cl. 360/244.2; G9B/5.147

(57) ABSTRACT

According to one embodiment, a magnetic head assembly includes a magnetic head, a tang portion, a pair of arm portions, a connecting portion, a flexure, a load beam, and a damper. The tang portion supports the magnetic head. The arm portions support the tang portion, and are connected to the tang portion while being connected to each other at a rear side of the tang portion. The connecting portion connects the arm portions. The flexure has a narrow portion being narrow in the width direction behind the connecting portion. The flexure guides wirings extending backward the narrow portion to be connected to the magnetic head. The load beam extends in the front-back direction while supporting the flexure, and has an opening through which a portion of the flexure is exposed. The damper is arranged on the load beam and the portion of the flexure.

### CROSS-REFERENCE TO RELATED APPLICATIONS

This application is based upon and claims the benefit of priority from Japanese Patent Application No. 2008-256737, filed Oct. 1, 2008, the entire contents of which are incorporated herein by reference.

### BACKGROUND

1. Field

One embodiment of the invention relates to a magnetic head assembly provided with a magnetic head configured to access a magnetic disk, and a magnetic disk device that includes the magnetic head assembly.

2. Description of the Related Art

In magnetic disk devices, a magnetic head is floated with a minute space over a rotating magnetic disk to record data on and reproduce data from the magnetic disk (hereinafter, the operations of recording and reproducing are referred together to as “access”). To float the magnetic head keeping a minute space over the magnetic disk stably without fluctuations, a structure called suspension is used that supports the magnetic head flexibly in the floating direction and the twisting direction, and rigidly in the in-plane direction, thereby achieving precise positioning.

Responding to recent improvement of magnetic disks to large-capacity high-recording density disks, the floating amount of the magnetic head is set to 10 nm or less to realize the large capacity high recording density, and influence of disturbance of an air flow accompanying the high speed rotation of the magnetic disks has become considerably large. The track pitch of recent magnetic disks is 0.3 μm or less. In magnetic disk devices where nano-order accuracy is required for positioning of the magnetic head, the suspension having the magnetic head mounted thereon vibrates because of an air flow. This makes it difficult to achieve accurate positioning, resulting in off-track.

Particularly, although a gimbal of the flexure, which directly supports the magnetic head, is designed to be very flexible in the floating direction and the twisting direction to follow the vibration of the magnetic disk, the gimbal is further close to the surface of the magnetic disk because the magnetic head becomes thinner, and is increasingly prone to be affected by the disturbance of an air flow (air disturbance).

Japanese Patent Application Publication (KOKAI) No. 2006-221726 discloses a conventional technology to cope with this vibration of the gimbal. In the conventional technology, a dampers is affixed to both the gimbal of the flexure and a load beam from the flexure side, or from the load beam side to suppress vibration of the gimbal of the flexure.

However, if a damper is affixed on the flexure side, since the thickness of magnetic heads has been reduced and, in the future, further reduction in thickness of magnetic disks is expected, a damper is required to be thinner because the damper and the magnetic disk are to be arranged more closer to each other. As a result, the vibration suppressing effect degrades.

On the other hand, if a damper is affixed on the load beam side, with the conventional technology, the flexure is arranged to be wider than the load beam and a damper is affixed such that the damper sticks out from both sides of the load beam. In such a structure, while a damper having sufficient thickness can be used, it is difficult to provide the gimbal of the flexure with a flexible structure because the flexure is required to be wider than the load beam. Moreover, if a structure in which a rail is formed by bending the both sides in the width direction of the load beam toward the opposite side to the flexure is applied to reduce the weight of the load beam, it is difficult to affix a damper to the flexure from the load beam side over the rail even if the flexure is formed to be wide because the rail is to be an obstacle. Although it is possible to partially separate the rail to affix a damper, this can deteriorate other vibration modes of the load beam. Therefore, it is not the best plan.

Moreover, with reduction in size and thickness of magnetic heads, further flexible structure is required of the gimbal of the flexure. If flexibility is pursued, decrease in resistance to a stress repeatedly applied at running away or at loading/unloading is predicted. If the resistance to such a stress is low, a break can occur in wirings of the flexure, which causes a malfunction. Displacement of the magnetic head is remarkably small at the time of collision to a stopper on the inner side (the rotation center side of the magnetic disk) because of air-film stiffness, and accordingly, a stress applied on the gimbal is also small. On the other hand, at the time of collision to a stopper on the outer side (outside in the radius direction of the magnetic disk), the magnetic head is unrestrained and a large stress is generated by deformation in the roll direction.

Japanese Patent Application Publication (KOKAI) No. 2005-267715 discloses a carriage structure in which a blade spring is provided around a pivot, and displacement in the out-of-plane direction is enabled, thereby preventing collision between the head and the disk at the time of running away. Japanese Patent Application Publication (KOKAI) No. 2005-267716 discloses a carriage structure in which two protrusions are provided in the carriage, a stopper is arranged therebetween, and running away to the inner/outer is controlled by one stopper. Japanese Patent Application Publication (KOKAI) No. H10-11929 discloses a structure in which gimbal arms are arranged in a snowshoe form, thereby absorbing shock in the in-plane direction. Japanese Patent Application Publication (KOKAI) No. H11-066781 discloses a structure in which a narrow portion is formed in a load beam, a roof is formed on a rear surface of a slider, and a limiter for drop impact is provided.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a magnetic disk device according to an embodiment of the invention;

FIG. 2 is an exemplary perspective view of a magnetic head assembly that constitutes the magnetic disk device illustrated in FIG. 1 in the embodiment;

FIG. 3 is an exemplary perspective view illustrating a primary twisting mode at an end portion constituting gimbals of a flexure in the embodiment;

FIGS. 4A and 4B are exemplary plan views of an end portion of the magnetic head assembly in the embodiment; and

FIGS. 5A and 5B are exemplary plan views of an end portion of a conventional magnetic head assembly as a comparative example.

### DETAILED DESCRIPTION

Various embodiments according to the invention will be described hereinafter with reference to the accompanying drawings. In general, according to one embodiment of the invention, a magnetic head assembly comprises a magnetic head, a tang portion, a pair of arm portions, a connecting portion, a flexure, a load beam, and a damper. The tang portion is configured to support the magnetic head. The arm portions are configured to support the tang portion. The arm portions are connected to the tang portion while passing both sides of the tang portion to be connected to each other at a rear side of the tang portion. The connecting portion is configured to connect the arm portions. The flexure comprises a narrow portion configured to be narrow in the width direction at a portion behind the connecting portion. The flexure is configured to guide wirings extending further backward to the narrow portion to be connected to the magnetic head. The load beam extends in the front-back direction while supporting the flexure on a first-surface side. The load beam comprises an opening through which a portion of the flexure at a position backward to the tang portion is exposed. The damper is configured to be arranged on both the load beam and the portion of the flexure exposed through the opening from a second-surface side of the load beam.

According to another embodiment of the invention, a magnetic disk device comprises a magnetic head assembly and a magnetic disk. The magnetic head assembly comprises a magnetic head, a tang portion, a pair of arm portions, a connecting portion, a flexure, a load beam, and a damper. The tang portion is configured to support the magnetic head. The arm portions are configured to support the tang portion. The arm portions are connected to the tang portion while passing both sides of the tang portion to be connected to each other at a rear side of the tang portion. The connecting portion is configured to connect the arm portions. The flexure comprises a narrow portion configured to be narrow in the width direction at a portion behind the connecting portion. The flexure is configured to guide wirings extending further backward to the narrow portion to be connected to the magnetic head. The load beam extends in the front-back direction while supporting the flexure on a first-surface side. The load beam comprises an opening through which a portion of the flexure at a position backward to the tang portion is exposed. The damper is configured to be arranged on both the load beam and the portion of the flexure exposed through the opening from a second-surface side of the load beam. The magnetic disk is configured to be rotated. The magnetic head magnetically reads data from and writes data to the magnetic disk.

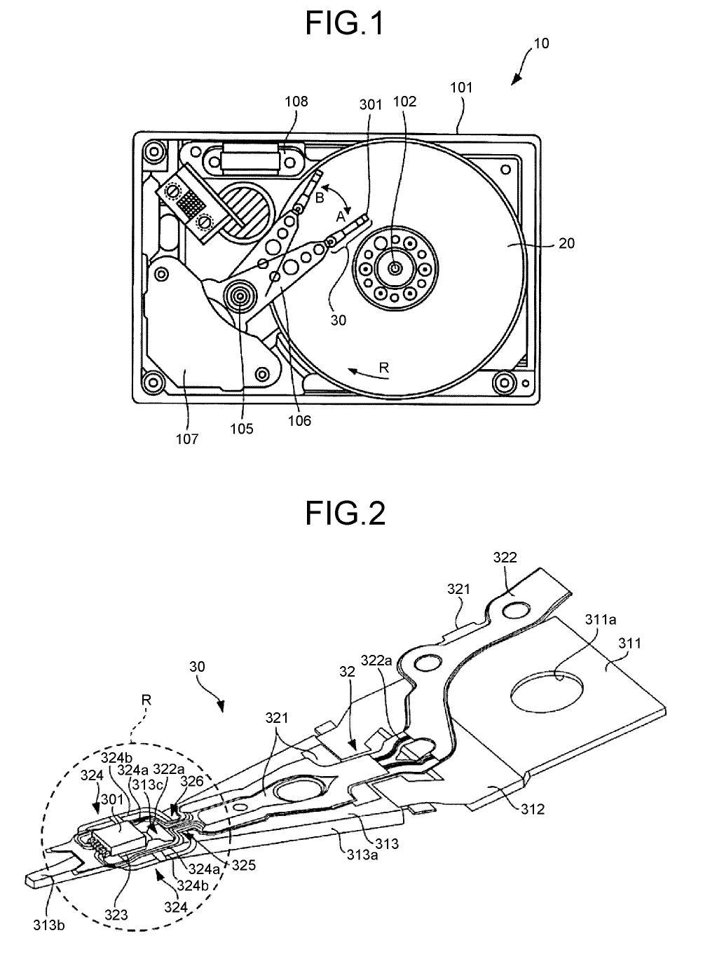

FIG. 1 is a schematic diagram of a magnetic disk device.

As illustrated in FIG. 1, a housing 101 of a magnetic disk device 10 houses a magnetic disk 20 that is mounted on a rotation axis 102 to be rotated, a magnetic head assembly 30 that holds a magnetic head 301 that record data on and reproduces data from (access) the magnetic disk 20 at an end, a carriage arm 106 to which the magnetic head assembly 30 is fixed and that moves along a surface of the magnetic disk 20 about an arm axis 105 as the center, and an arm actuator 107 that drives the carriage arm 106.

The magnetic disk 20 magnetically records data by application of a magnetic field carrying the data. Upon recording of the data on the magnetic disk 20 and reproduction of the data recorded on the magnetic disk 20, the carriage arm 106 is driven by the arm actuator 107, and the magnetic head 301 is positioned on a desirable track on the rotating magnetic disk 20. The magnetic head 301 goes over the desirable track on the magnetic disk with the rotation of the magnetic disk 20, to record data sequentially.

Upon accessing the magnetic disk 20, the arm actuator 107 moves the magnetic head 301 over the magnetic disk 20 (loading). When access to the magnetic disk is not required, the arm actuator 107 moves the magnetic head 301 to the position of a ramp 108 to make it standby (unloading).

Moreover, although not illustrated, the magnetic disk device 10 is provided with an inner stopper and an outer side stopper. When the carriage arm 106 excessively moves toward the inner side (arrow A side), the carriage arm 106 abuts on the inner stopper, thereby preventing runaway toward the inner side. When the carriage arm 106 excessively moves toward the outer side (arrow B side), the carriage arm 106 abuts on the outer stopper, thereby preventing runaway toward the outer side.

FIG. 2 is a perspective view of the magnetic head assembly 30 that constitutes the magnetic disk device 10. FIG. 2 illustrates the magnetic head assembly 30 with side facing the magnetic disk 20 (see FIG. 1) up, which is opposite the side of the magnetic head assembly 30 illustrated in FIG. 1.

The magnetic head assembly 30 comprises a base plate 311 in which a hole 311a is formed at which the magnetic head assembly 30 is fixed by swaging to an end of the carriage arm 106 illustrated in FIG. 1 and a load beam 313 that is connected to the base plate 311 through a hinge 312 having a spring property. The load beam 313 extends in the front-back direction, and a rear end is connected to the hinge 312, and a lift tab 313b that is supported by the ramp 108 (see FIG. 1) at unloading is formed at a front end. The both sides in the width direction of the load beam 313 are bent downward in FIG. 2 (toward the side away from the magnetic disk 20 (see FIG. 1), i.e., a second-surface side, which is opposite to a first-surface side of the load beam 313 described later) to form a rail 313a. The stiffness of the load beam 313 is increased by the rail 313a, and accordingly, the load beam 313 can be thinner and lighter.

In the load beam 313, a flexure 32 is supported on a first-surface side, i.e., the side facing the magnetic disk 20 (see FIG. 1). The flexure 32 extends in the front-back direction that is the same as the direction in which the load beam 313 extends. The flexure 32 comprises a base material 321 formed with a thin plate of stainless steel and a flexible substrate 322 supported by the base material 321. The flexible substrate 322 comprises an insulting layer on the side of the base material 321, wirings 322a that are arranged sandwiching the insulating layer with the base material 321 and that is connected to the magnetic head 301, and a protective layer that sandwiches the wirings 322a with the insulating layer. This protective layer is partially not formed, and the wirings 322a are exposed.

The magnetic head 301 is mounted at an end portion of the flexure 32 indicated by a circuit R, and the end portion is referred to as gimbals.

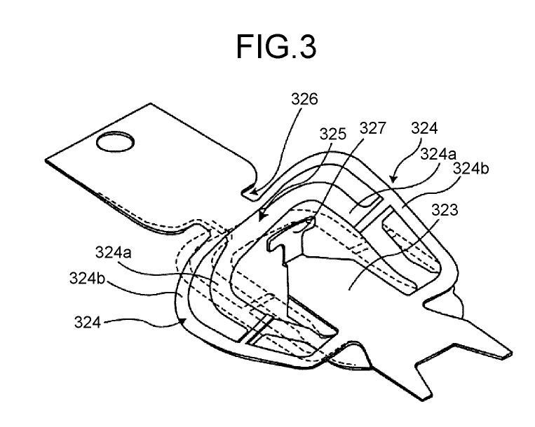

FIG. 3 is a perspective view illustrating a primary twisting mode of the end portion constituting the gimbals of the flexure.

The flexure 32 comprises, at the end portion, a tang portion 323 that supports the magnetic head 301 (see FIG. 2), a pair of arm portions 324 that are connected to the tang portion 323, and are connected to each other at the other side of the tang portion 323 passing both sides of the tang portion 323, respectively, a connecting portion 325 which connects the arm portions 324, and a narrow portion 326 that is narrow in the width direction at a position behind the connecting portion 325. In the tang portion 323, the magnetic head is mounted on the opposite side to the side illustrated in FIG. 3.

Broken lines indicate the arm portions 324 before deformation. The arm portions 324 are structured to be able to deform flexibly as illustrated so that the magnetic head can follow twisting of the magnetic disk. Furthermore, in this example, the respective arm portions 324 on the both sides constituting the arm portions 324 are further branched into two arms 324a and 324b, this enhances flexibility.

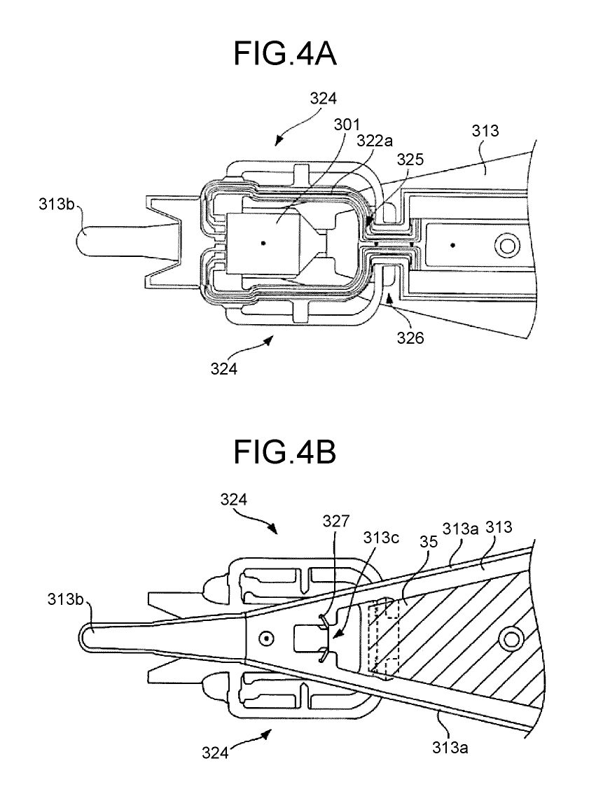

Moreover, at a rear end of the tang portion 323, a limiter 327 rising from the tang portion 323 is provided. The limiter 327 is engaged in an opening 313c (see FIG. 2 and FIGS. 4A and 4B) of the load beam 313 illustrated in FIG. 2 and prevents the magnetic head 301 mounted on the tang portion 323 from coming off from the load beam 313 when shock or the like is applied to the end portion of the flexure 32. The flexure 32 has the narrow portion 326 formed thereon, and when colliding with the outer stopper, the flexure 32 twists in the roll direction from the narrow portion 326, thereby reducing the generated stress. Thus, break of the wirings 322a at the arm portions 324 and the like are prevented.

Referring back to FIG. 2, explanation of FIG. 2 is elaborated.

The flexible substrate 322 constituting the flexure 32 has narrower width than the base material 321 at the narrow portion 326 and is positioned inside the base material 321. Accordingly, the wirings 322a at the narrow portion 326 are laid inside the base material 321. Besides, the wirings 322a pass through the arm portions 324 from the narrow portion 326 to be connected to the magnetic head 301. While the arm portions 324 are each branched into the two arms 324a and 324b on right and left, the wirings 322a are supported by the inner arms 324a of the arms 324a and 324b on both sides.

In the load beam 313, the opening 313c is formed through which a portion of the flexure 32 positioned rearward to the tang portion 323 is exposed to the second-surface side of the load beam 313. Specifically, the opening 313c is formed at such a position that a boundary area between the narrow portion 326 of the flexure 32 and the connecting portion 325 at which the arm portions 324 are connected to each other is viewed therethrough. The width of the opening 313c is wider than the entire width of the narrow portion 326, and the entire portion in the width direction of the narrow portion 326 is viewed through the opening 313c. The opening 313c opens forward, and the limiter 327 is engaged at a front end of the opening 313c.

FIG. 4A is a plan view of the end portion of the magnetic head assembly of the embodiment viewed from the magnetic head side (magnetic disk side). FIG. 4B is a plan view of the end portion of the magnetic head assembly viewed from the opposite side of the magnetic head side.

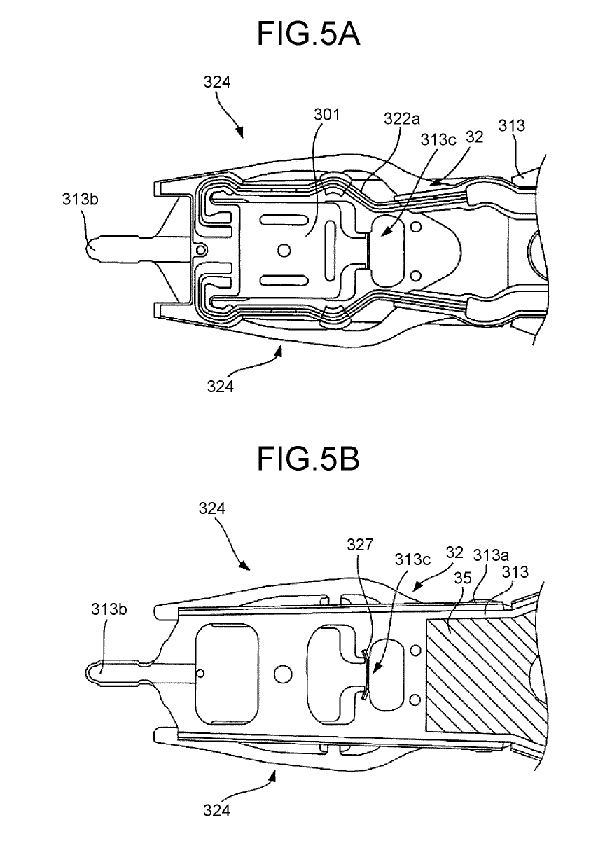

FIG. 5A is a plan view of an end portion of a conventional head assembly as a comparative example viewed from a magnetic head side (magnetic disk side). FIG. 5B is a plan view of the end portion of the conventional head assembly viewed from the opposite of the magnetic head side. For simplicity of comparison with the embodiment, like reference numerals refer to corresponding components even if there is difference in shapes.

In FIGS. 4A and 4B, a damper 35 is affixed to the load beam 313 on the second-surface side. The damper 35 extends to a part of the opening 313c formed in the load beam 313, and is affixed also to the narrow portion 326 and the connecting portion 325 of the flexure 32. The affixed damper 35 enables to suppress excessive vibration even if air disturbance is applied, and the magnetic head 301 is flexibly and stably held.

In the conventional example illustrated in FIGS. 5A and 5B, the opening 313c of the load beam 313 is formed just to engage the limiter 327 regardless of the damper 35. The damper 35 is affixed only to the load beam 313, and is not affixed to the flexure 32. Therefore, the flexure 32 is affected by air disturbance. Even if, in the conventional example illustrated in FIGS. 5A and 5B, the damper 35 is arranged to be wider than the load beam 313, and further, the flexure 32 is also made wider if necessary and the damper 35 is to be affixed to a portion sticking out of the load beam 313 in the width direction, because the rail 313a is formed on the both sides of the load beam 313, it is structurally impossible to affix the damper 35 over the rail 313a. Further, if the damper is to be affixed from the side of the flexure 32 (the side illustrated in FIG. 5A) as described previously, the thickness of the damper is restrained due to the decreased thickness of the magnetic head 301, and therefore, it is difficult to obtain sufficient damping effect.

In the embodiment, as illustrated in FIGS. 4A and 4B, the opening 313c through which the flexure 32 is exposed is formed in the load beam 313, and the damper 35 is affixed also to the flexure 32 through the opening 313c. This suppresses vibration of the flexure 32.

Moreover, in the embodiment, the narrow portion 326 is formed in the flexure 32. The narrow portion 326 twists when the flexure 32 is shocked, thereby suppressing deformation of the wirings 322a on the arm portions 324. Thus, break of the wirings 322a and the like are prevented.

On the other hand, in the conventional example illustrated in FIGS. 5A and 5B, the narrow portion 326 as in the embodiment is not provided. Therefore, when it is shocked, the shock deforms the arm portions 324. This causes large stress on the wirings 322a on the arm portions 324, resulting in break of wirings and the like.

As described above, in the embodiment, the narrow portion 326 is formed in the flexure 32, and the damper 35 is affixed to the narrow portion 326 and the connecting portion 325 of the flexure 32 through the opening 313c from the side of the load beam 313. Therefore, the magnetic head 301 is flexibly and stably held, and break of wirings is prevented.

As set forth hereinabove, according to an embodiment of the invention, in a magnetic head assembly, an opening is formed in a load beam, and a damper is arranged on both the load beam and flexure that are exposed through the opening. This arrangement of the damper maintains stability against disturbance while preventing loss of flexibility due to the wide flexure. The damper is arranged on the side of the load beam, restraint in thickness thereof is not severe, and sufficient damping property can be obtained.

Moreover, in the magnetic head assembly, a narrow portion is formed in the flexure. Therefore, generated stress is reduced by twisting in the roll direction from the narrow portion. This prevents break of the wirings of the flexure.

Furthermore, a magnetic disk device comprises the magnetic head assembly, and a magnetic disk that is rotated and on which data is magnetically recorded and from which data is magnetically read by the magnetic head constituting the magnetic head assembly.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic head assembly comprising:
a magnetic head;
a tang portion configured to support the magnetic head;
a pair of arm portions configured to support the tang portion, the arm portions being connected to the tang portion while passing both sides of the tang portion, respectively, to be connected to each other at a rear side of the tang portion;
a connecting portion configured to connect the arm portions;
a flexure comprising a narrow portion configured to be narrow in a width direction at a portion behind the connecting portion, the flexure configured to guide wirings extending further backward to the narrow portion to be connected to the magnetic head;
a load beam extending in a front-back direction while supporting the flexure on a first-surface side, the load beam comprising an opening through which a portion of the flexure at a position backward to the tang portion is exposed; and
a damper configured to be arranged on both the load beam and the portion of the flexure exposed through the opening from a second-surface side of the load beam.

2. The magnetic head assembly according to claim 1, wherein the opening of the load beam is configured to expose an entire width of the narrow portion in the width direction of the narrow portion, the opening being located at a position where at least a boundary area between the narrow portion and the connecting portion is exposed in the front-back direction.

3. The magnetic head assembly according to claim 1, wherein the load beam comprises rail portions on both width-direction sides of the load beam, the rail portions rising on the second-surface side and extending in the front-back direction.

4. The magnetic head assembly according to claim 1, wherein
the flexure comprises
a base material made of metal in a plate shape, and
a flexible substrate on the base material, the flexible substrate including the wirings,
the flexible substrate is configured to be narrower than the base material at least at the narrow portion in the width direction, and positioned inside the base material.

5. A magnetic disk device comprising:
a magnetic head assembly comprising
a magnetic head,
a tang portion configured to support the magnetic head,
a pair of arm portions configured to support the tang portion, the arm portions being connected to the tang portion while passing both sides of the tang portion, respectively, to be connected to each other at a rear side of the tang portion,
a connecting portion configured to connect the arm portions,
a flexure comprising a narrow portion configured to be narrow in a width direction at a portion behind the connecting portion, the flexure configured to guide wirings extending further backward to the narrow portion to be connected to the magnetic head,
a load beam extending in a front-back direction while supporting the flexure on a first-surface side, the load beam comprising an opening through which a portion of the flexure at a position backward to the tang portion is exposed, and
a damper configured to be arranged on both the load beam and the portion of the flexure exposed through the opening from a second-surface side of the load beam; and
a magnetic disk configured to be rotated, the magnetic head magnetically reading data from and writing data to the magnetic disk.
